(19) United States
(12) Patent Application Publication
(10) Pub. No.: US 2016/0064164 A1
(43) Pub. Date: Mar. 3, 2016

(54) KEY APPARATUS

(71) Applicant: HON HAI PRECISION INDUSTRY CO., LTD., New Taipei (TW)

(72) Inventors: CHIA-SHOU CHANG, New Taipei (TW); HUANG-CHIN LIAO, New Taipei (TW); YAO-CHE PENG, New Taipei (TW)

(21) Appl. No.: 14/543,370

(22) Filed: Nov. 17, 2014

(30) Foreign Application Priority Data
Aug. 26, 2014 (TW) 103129430

(51) Int. Cl. H01H 13/10; H01H 13/14; H01H 13/52

(52) U.S. Cl. CPC H01H 13/10; H01H 13/52; H01H 13/14; H01H 2223/054; H01H 2221/044; H01H 2227/028

(57) ABSTRACT

A key apparatus includes a housing, a printed circuit board (PCB), a fixing mechanism, and a key mechanism. The fixing mechanism mounted on the PCB. The key mechanism is rotatably fixed on the fixing mechanism. Partial of the key mechanism is exposed from the housing. The fixing mechanism comprises a resistor portion for providing a changeable resistance to the PCB. The key mechanism drives the resistor portion to rotate simultaneously for changing a resistance of resistor portion provided to the PCB. A rotating axis of the key mechanism is coaxial with a rotating axis of the resistor portion.

### CROSS-REFERENCE TO RELATED APPLICATIONS

This application claims priority to Taiwanese Patent Application No. 103129430 filed on Aug. 26, 2014, the contents of which are incorporated by reference herein.

### FIELD

The present disclosure relates to key apparatuses for improving touch sensitivity.

### BACKGROUND

Key apparatus, such as a game controller, includes at least one pressed key, at least one rubber portion with conductive particles, and at least one pressing film. When the key is pressed, the corresponding conductive particle connects with the pressing film for generating a corresponding control signal which corresponds to a range of the connected area.

### BRIEF DESCRIPTION OF THE FIGURES

Implementations of the present technology will now be described, by way of example only, with reference to the attached figures.

FIG. 1 is an isometric view of an embodiment of a key apparatus.

FIG. 2 is an exploded view of an embodiment of the key apparatus of FIG. 1, the key apparatus comprising a fixing mechanism and a key mechanism.

FIG. 3 is an isometric view of an embodiment of the fixing mechanism of FIG. 2.

FIG. 4 is an isometric view of an embodiment of the key mechanism of FIG. 2.

FIG. 5 is an isometric view of an embodiment of the fixing mechanism and the key mechanism of FIG. 1.

FIG. 6 is a cross-sectional view of an embodiment of the key apparatus of FIG. 1, taken along a line VI-VI thereof.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

A key apparatus capable of improving touch sensitivity is described.

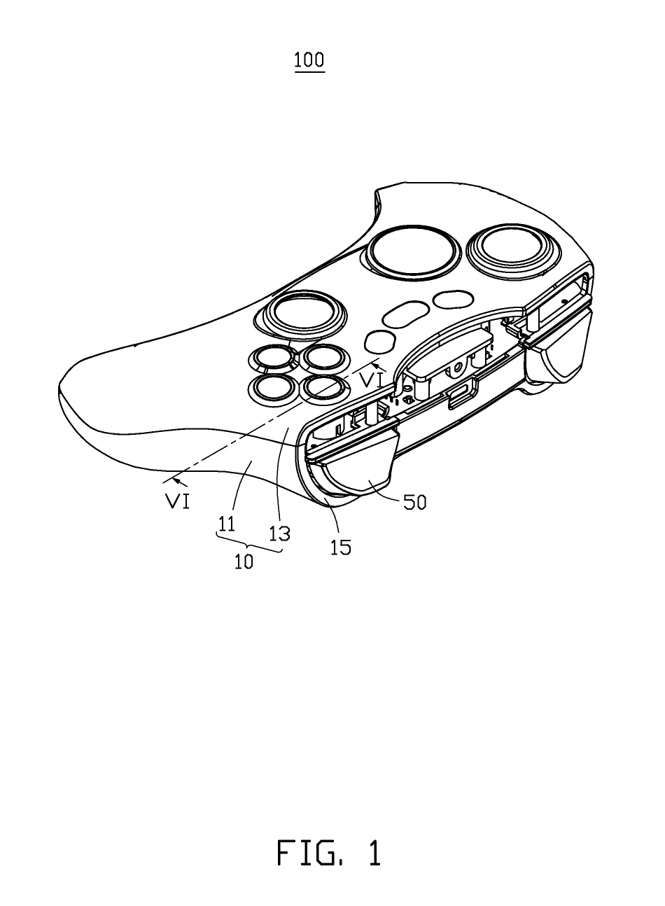

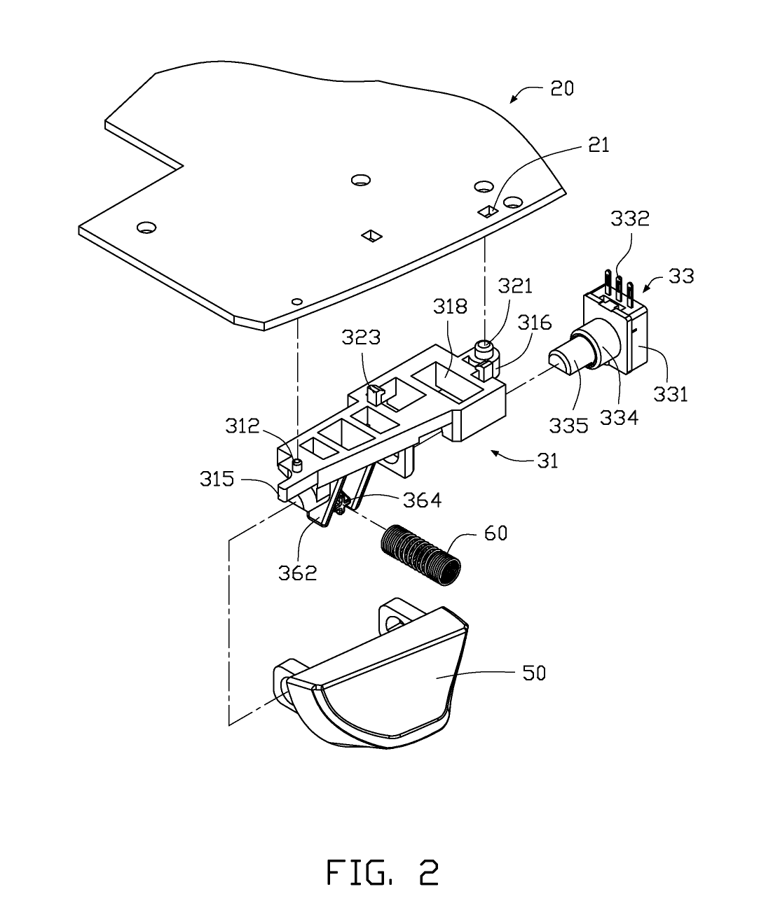

FIGS. 1-2 illustrate a key apparatus 100 of the embodiment. The key apparatus 100 generates different control signals based on different pressures for controlling an external device to execute a corresponding function. In the embodiment, the key apparatus 100 is a game controller.

The key apparatus 100 includes a housing 10, a printed circuit bard (PCB) 20, a fixing mechanism 30, a key mechanism 50, and an elastic mechanism 60. The PCB 20, the fixing mechanism 30, and the elastic mechanism 60 are received in the housing 10. The fixing mechanism 30 is mounted on the PCB 20. The key mechanism 50 is rotatably fixed on the fixing mechanism 30, and partial of the key mechanism 20 is exposed from the housing 10.

The housing 10 includes an upper cover 11 and a bottom cover 13 cooperated with the upper cover 11 to define a receiving space (not shown). The bottom cover 11 defines an opening 15.

The PCB 20 is sandwiched between the upper cover 11 and the bottom cover 13. The PCB 20 defines a plurality of through holes 21.

The fixing mechanism 30 fixes positions of the key mechanism 50 and the elastic mechanism 60. The fixing mechanism 50 exposes out of the housing 10 via the opening 15. The fixing mechanism 30 includes a fixing portion 31, a locking portion 32, a resistor portion, a positioning plate 34, a resisting portion 36, and a first pivot 38.

The fixing portion 31 is a substantially flat plate. The fixing portion 31 includes a first surface 312 faced to the PCB 20, a second surface 314 opposite to the first surface 312, a first end 315, a second end 316 opposite to the first end 315, and a receiving portion 318 adjacent to the second end 316. The second surface 314 is faced to the bottom cover 13. The first end 315 and the second end 316 are extended from the first surface 312 in opposite directions, which are substantially coplanar with the first surface 312. The first end 315 is substantially L-shaped. The first end 315 is capable of resisting with the key mechanism 50 for limiting a rotating degree of the key mechanism 50. The receiving portion 318 passes through the first surface 312 and the second surface 314. The receiving portion 318 defines a gap 319. The gap 319 is substantially D-shaped.

The locking portion 32 locks the fixing portion 31 on the PCB 20. The locking portion 32 includes a protruding post 321, a first clasp 323, and a second clasp 325, which are located on the first surface 312. The protruding post 321 is located on the second end 316. The first clasp 323 is adjacent to the second end 316. The second clasp 325 is opposite to the protruding post 321. The first clasp 323 and the second clasp 325 respectively correspond to a through hole 21. In other embodiments, the locking portion 32 can include more than two clasps.

The resistor portion 33 provides a changeable resistance to the PCB 20, and is electrically connected with the PCB 20. The resistor portion 33 is received in the receiving portion 318. The resistor 33 includes a main body 331, a plurality of pins 332, a connecting portion 334, and a second pivot 335. The pin 332 is perpendicular to a bottom surface of the main body 331, and is perpendicular to the upper cover 11. The connecting portion 334 is substantially cylindrical shaped. The connecting portion 334 is located on a surface of the main body 331 perpendicular to the pin 332, and is received in the gap 319. The second pivot 335 is rotatably mounted on a bottom surface of the connecting portion 334. The second pivot 335 is coaxial to the connecting portion 334. The second pivot 335 is substantially D-shaped.

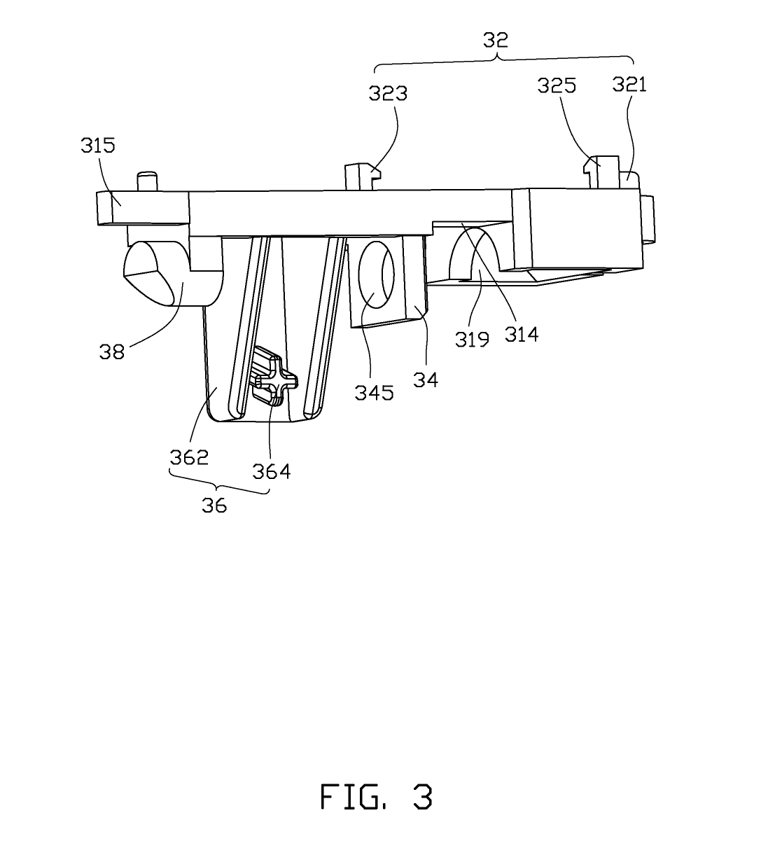

FIG. 3 illustrates the fixing mechanism 30 from another angle. The positioning plate 34, the resisting portion 36, and a first pivot 38 are orderly located on the second surface 314, which are spaced from each other in a distance. The positioning plate 34 adjacent to the gap 319 is a substantially flat plate. The positioning plate 34 defines a first pivot hole 345 faced to the gap 319. The first pivot hole 345 is substantially circle shaped.

The resisting portion 36 prevents the elastic mechanism 60 from moving along a horizontal direction. The resisting portion 36 is perpendicularly extended from the second surface 314. The resisting portion 36 is substantially U-shaped, and includes two parallel sidewalls 362 and a positioning pole 364. The sidewall 362 is substantially trapezoid shaped. Widths of the sidewall 362 are gradually decreased along a direction adjacent to the bottom cover 13. The positioning pole 364 is sandwiched between the sidewalls 362. The positioning pole 364 is a substantially cross shaped. The positioning pole 364 is extended from the second surface 314 along a first direction angled with the second surface 314.

The first pivot 38 is perpendicularly located on the first end 315. The first pivot 38 is substantially L-shaped. A rotating axis of the first pivot 38 is coaxial with a rotating axis of the second pivot 335.

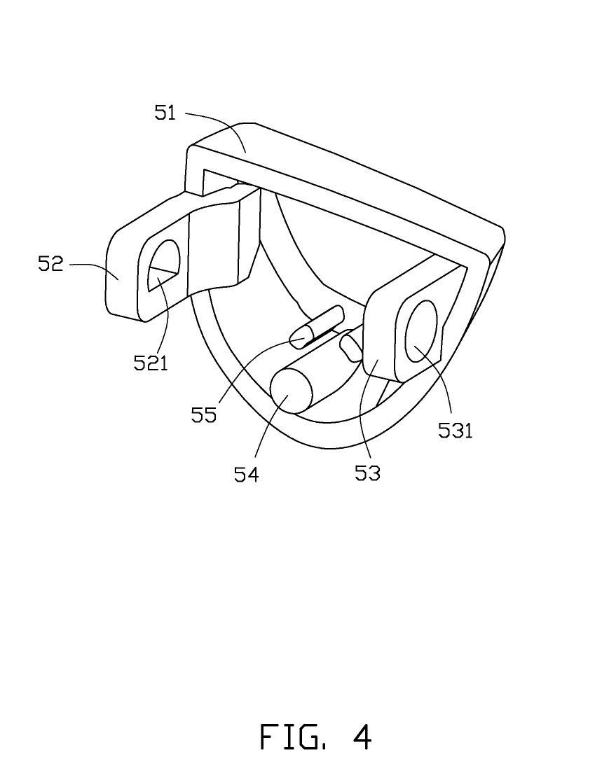

FIG. 4 illustrates then embodiment of the key mechanism 50. The key mechanism 50 includes a key 51, a first plate 52, a second plate 53, a fixing post 54, and two limiting portions 55. A cross section of the key 51 is substantially hollow arch shaped. Thicknesses of the key 51 are gradually decreased along a direction adjacent to the bottom cover 13. The first plate 52 and the second plate 53 are perpendicularly extended from opposite edges of the key 51, which are perpendicular to the fixing mechanism 30. The first plate 52 defines a coupling hole 521. The coupling hole 521 is substantially D-shaped. The second plate 53 defines a second pivot hole 531 faced to the coupling hole 521. The fixing post 54 is perpendicularly extended from a surface of the key 51 facing to the fixing mechanism 30. The fixing post 54 is located below the first plate 52 and the second plate 53. The fixing post 54, the first plate 52, and the second plate 53 form an equilateral triangle. A distance between the fixing post 54 and the first plate 52 is equal to a distance between the fixing post 54 and the second plate 53. The limiting portions 55 are symmetrically mounted around the fixing post 54. The limiting portion 55 locates a position of the elastic mechanism 60 related to the key mechanism 50. In at least one embodiment, a height of the limiting portion 55 is less than a height of the fixing post 54. In other embodiments, the key mechanism 50 can include more than two limiting portions 55.

The elastic mechanism 60 provides an elastic force when the key mechanism 50 is being pressed. An end of the elastic mechanism 60 is sleeved on the protruding post 54 and resists with the limiting portions 55. An opposite end of the elastic mechanism 60 is sleeved on the positioning pole 364.

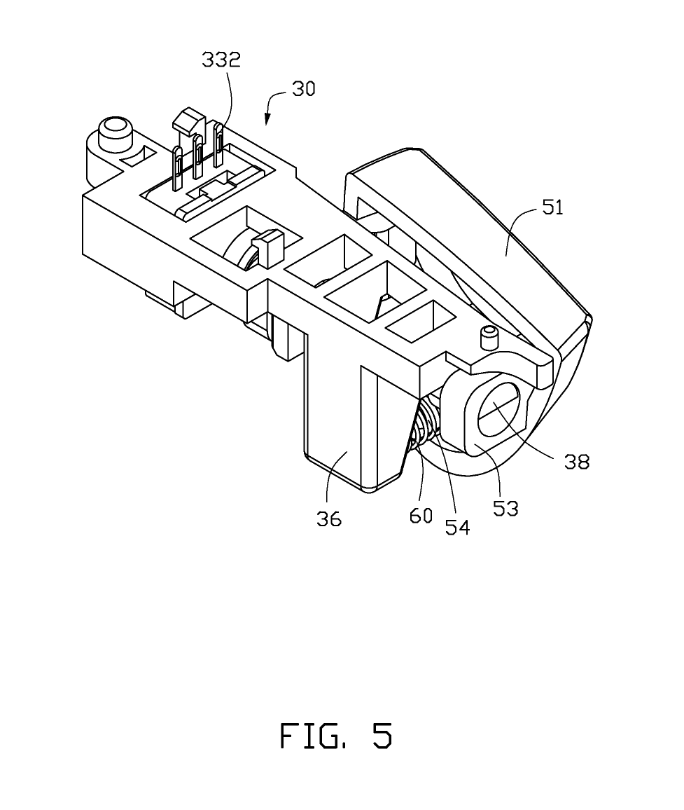

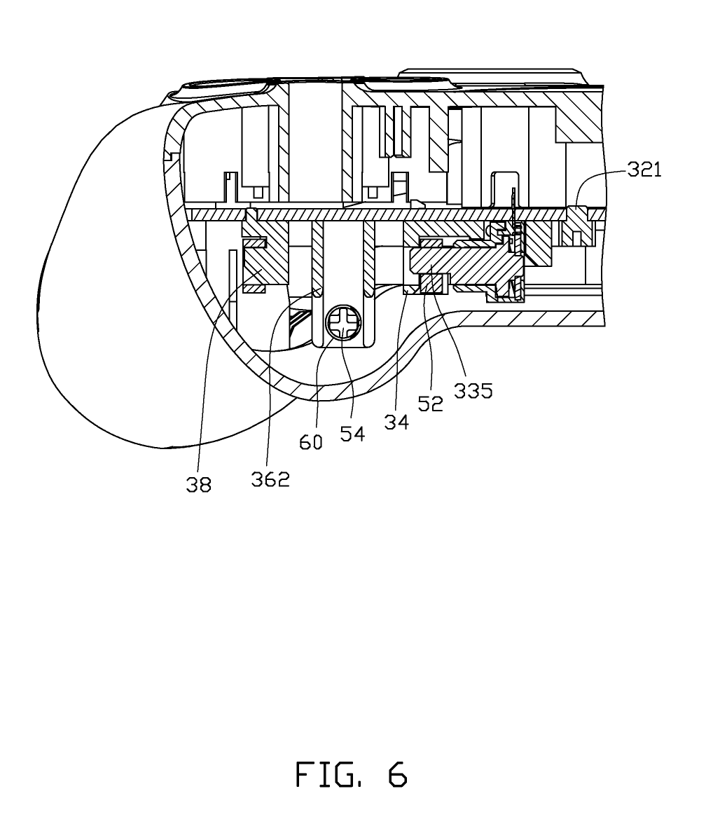

FIGS. 5-6 illustrate an embodiment of the key apparatus 100 in assembly. The protruding post 321 passes through the corresponding through hole 21, the first clasp 323 and the second clasp 325 clasp on the PCB 20 via the corresponding through holes 21, which causes the fixing portion 31 mounted on the PCB 20. The resistor portion 33 is received in the receiving portion 318. The pins 332 are inserted into the PCB 20, which causes the resistor portion 33 electrically connected with the PCB 20. The connecting portion 334 is received in the gap 319. The second pivot 335 is received in the coupling hole 521 via the first pivot 345, and the first pivot 38 is received in the first pivot hole 531, which causes the key 21 and the resistor portion 33 rotatably mounted on the fixing portion 31.

When being pressed by an external force, the key mechanism 50 rotates adjacent to the bottom cover 13 related to the first pivot 38, which causes the elastic mechanism 60 generate an elastic force. The second pivot 335 driven by the first plate 52 rotates along a same direction of the first pivot 38, which causes a resistance of the resistor portion 33 changed. The PCB 20 generates a corresponding control signal. When the external force is released, the generated elastic force by the elastic mechanism 60 drives the key 51 resumes to an original position.

In use, the key mechanism 50 and the resistor portion 33 rotate along a same pivot axis, a room cost by the fixing mechanism 30 is reduced, and a sensitivity of the key apparatus 100 is improved by the resistor portion 33.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A key apparatus, comprising:
a housing;
a printed circuit board (PCB);
a fixing mechanism mounted on the PCB; and
a key mechanism rotatably fixed on the fixing mechanism;
wherein the PCB, the fixing mechanism, and the key mechanism are received in the housing; a portion of the key mechanism is exposed from the housing; the fixing mechanism comprises a resistor portion; the key mechanism drives the resistor portion to rotate; and a rotating axis of the key mechanism is coaxial with a rotating axis of the resistor portion.

2. The key apparatus of claim 1, wherein the fixing mechanism further comprises a first clasp and a second clasp; the PCB defines a plurality of through holes; the first clasp and the second clasp are located on a same surface; the first clasp and the second clasp lock with the PCB via the corresponding through holes.

3. The key apparatus of claim 1, wherein the fixing mechanism further comprises a receiving portion and a positioning plate adjacent to the receiving portion; the key mechanism comprises a first plate; the resistor portion comprises a main body and a first pivot rotatably mounted on the main body; the main body is received in the receiving portion; the positioning plate defines a first pivot hole; the first pivot engages with the first plate by passing through the first pivot hole; the first pivot rotates in the first pivot hole when the key mechanism is rotated.

4. The key apparatus of claim 3, wherein the fixing mechanism further comprises a second pivot; the key mechanism further comprises a second plate parallel with the first plate; the second plate defines a second pivot hole; the second pivot rotatably received in the second pivot hole; a rotating axis of the second pivot is coaxial with a rotating axis of the first pivot.

5. The key apparatus of claim 3, wherein the first plate defines a coupling hole; the receiving portion further defines a gap faced to the positioning plate; the first pivot is engaged with the coupling hole by passing through the gap.

6. The key apparatus of claim 3, wherein the resistor portion further comprises a plurality of pins; the pins are perpendicularly mounted on a surface of the main body facing to the PCB; the pins are electrically connected with the PCB by passing through the receiving portion.

7. The key apparatus of claim 1, further comprising an elastic mechanism received in the housing; wherein the elastic mechanism provides an elastic force when the key mechanism is being pressed; when the external force is released, the key mechanism resumes to an original position based on the elastic force.

8. The key apparatus of claim 7, wherein the key mechanism further comprises a fixing post; an end of the elastic mechanism is sleeved on the fixing post.

9. The key apparatus of claim 7, wherein the fixing mechanism further comprises a positioning pole; an opposite end of the elastic mechanism is sleeved on the positioning pole.

10. The key apparatus of claim 1, wherein the fixing mechanism further comprises a first end; the first end resists with the key mechanism for limiting a rotating degree of the key mechanism.

11. A key apparatus, comprising:
a housing;
a printed circuit board (PCB);
a fixing mechanism mounted on the PCB; and
a key mechanism rotatably fixed on the fixing mechanism;
wherein the PCB, the fixing mechanism, and key mechanism are received in the housing 10; a portion of the key mechanism is exposed from the housing; the fixing mechanism comprises a resistor portion; the resistor portion is electrically connected to the PCB and provides a changeable resistance to the PCB; and the key mechanism drives the resistor portion to rotate for changing the resistance of the resistor portion provided to the PCB.

12. The key apparatus of claim 11, wherein the fixing mechanism further comprises a first pivot and a receiving portion; the resistor portion comprises a main body and a second pivot rotatably mounted on the main body; the main body is received in the receiving portion; the second pivot rotatably fixed with the key mechanism; the second pivot engages with the key mechanism by passing through the receiving portion; a rotating axis of the first pivot is coaxial with a rotating axis of the second pivot.

13. The key apparatus of claim 12, wherein the resistor portion further comprises a plurality of pins; the pins are perpendicularly mounted on a surface of the main body facing to the PCB; the pins are electrically connected with the PCB by passing through the receiving portion.

14. The key apparatus of claim 11, wherein the key mechanism comprises a first plate; the first plate defines a coupling hole; the fixing mechanism further comprises a positioning plate adjacent to the receiving portion; the positioning plate defines a second pivot hole; the second pivot engages with the first plate by passing through the first pivot hole.

15. The key apparatus of claim 14, wherein the key mechanism further comprises a second plate parallel with the first plate; the second plate defines a first pivot hole for receiving the first pivot.

16. The key apparatus of claim 11, further comprising an elastic mechanism received in the housing; wherein the elastic mechanism provides an elastic force when the key mechanism is being pressed; when the external force is released, the key mechanism resumes to an original position based on the elastic force.

17. The key apparatus of claim 16, wherein the key mechanism further comprises a fixing post; the fixing mechanism further comprises a positioning pole; an end of the elastic mechanism is sleeved on the fixing post; an opposite end of the elastic mechanism is sleeved on the positioning pole.

18. The key apparatus of claim 17, wherein the positioning pole is angled located on the fixing mechanism.

19. The key apparatus of claim 11, wherein the fixing mechanism further comprises a first clasp and a second clasp; the PCB defines a plurality of through holes; the first clasp and the second clasp are located on a same surface; the first clasp and the second clasp respectively locks with the PCB via the corresponding through holes.

20. The key apparatus of claim 11, wherein the fixing mechanism further comprises a first end; the first end resists with the key mechanism for limiting a rotating degree of the key mechanism.
